(19) United States
(12) Patent Application Publication
(10) Pub. No.: US 2019/0377903 A1
(43) Pub. Date: Dec. 12, 2019

(54) SYSTEM AND METHOD FOR PROCESSING A REQUEST TOKEN

(71) Applicant: DIVERSIFY FINANCE LIMITED, Toronto (CA)

(72) Inventor: Jennifer Anne FAGG, Toronto (CA)

(21) Appl. No.: 16/463,085

(22) PCT Filed: Nov. 24, 2017
(86) PCT No.: PCT/IB2017/057394

§ 371 Date: May 22, 2019

Related U.S. Application Data
(60) Provisional application No. 62/426,290, filed on Nov. 24, 2016.

(51) Int. Cl. G06F 21/62; G06Q 40/02; G06Q 50/16; H04L 9/32; G06Q 30/08; G06F 16/182

(52) U.S. Cl. CPC G06F 21/6263; G06Q 40/025; G06F 16/1834; H04L 9/3213; G06Q 30/08; G06Q 50/167

(57) ABSTRACT

A system and method for processing a request token. The request token includes request data classified into progressively informative data classes. The request token may be processed by a server which executes cycles of evaluation of the request token. Cycles include transmitting the request token, receiving responses to the request token, and, configuring the request token for disclosure of the data classes according to disclosure rules. System and methods for processing pluralities of request tokens are described.

### CROSS-REFERENCE TO RELATED APPLICATIONS

This application claims priority to U.S. 62/426,290, filed Nov. 24, 2016, the entirety of which is incorporated herein by reference.

### FIELD

The present disclosure relates generally to the transmission and processing of digital information.

### BACKGROUND

The volume of data being collected in the world is increasing. The data being collected on individuals is becoming increasingly tied to one's private life, and the data being collected in industry is becoming increasingly valuable for aiding in informed decision-making. Data collection, dissemination, and analysis, is thus becoming increasingly relevant.

The increasing volume and importance of data in the world has been matched by the increasing processing power of computers, which allows computation and analysis of large volumes of data in short periods of time, generally improving transactional efficiency where large volumes of data is relevant to informed decision-making. However, there are privacy concerns where there is an expectation by one party in a transaction that private or sensitive data of the other party will be made available to it for evaluating the transaction, and there are concerns about informational asymmetry where one party in a transaction has access to a larger volume of data than the other party.

### SUMMARY

According to an aspect of the disclosure, a system for processing a request token having progressively informative data classes includes a computer network, a requester, a plurality of competing recipients, a server in communication with the requester and the plurality of competing recipients via the computer network, the server configured to execute a method for processing a request token. The method involves receiving request data and disclosure rules from the requester, classifying the request data into a plurality of progressively informative data classes, the plurality of progressively informative data classes comprising a first data class and a second data class, the second data class including information supplementary to the first data class, tokenizing the request data according to the plurality of progressively informative data classes to generate a request token configured for disclosure of at least the first data class, and executing a cycle of evaluation of the request token, the executing involves transmitting the request token to the plurality of competing recipients, receiving responses to the request token from the plurality of competing recipients, and where the responses to the request token do not include acceptance of the request token, and where disclosure of the second data class is enabled according to the disclosure rules, configuring the request token for disclosure of at least the second data class, and initiating a subsequent cycle of evaluation of the request token.

In some embodiments, the disclosure rules designate a preferred recipient of the plurality of competing recipients, and the method for processing a request token involves, prior to transmitting the request token to the plurality of competing recipients, anonymizing the request data of personal identifying information, and the executing a cycle for evaluation of the request token involves, where the responses to the request token include acceptance, deanonymizing the request data to include personal identifying information, and providing a right of last preferred offer to the preferred recipient.

In some embodiments, the server is configured to execute the cycle of evaluation of the request token upon request of the preferred recipient, and the receiving request data and disclosure rules from the requester includes routing the request data and disclosure rules through the preferred recipient.

In some embodiments, the system further comprises a third party in communication with the server via the computer network, the server is configured to execute the cycle of evaluation of the request token upon request of the third party, and the receiving request data and disclosure rules from the requester includes routing the request data and disclosure rules through the third party.

In some embodiments, the method for processing a request token further comprises anonymizing the request data of personal identifying information.

According to another aspect of the disclosure, a system for processing request tokens includes a computer network, a requester, a plurality of competing recipients, a server in communication with the requester and the plurality of competing recipients via the computer network, the server configured to execute a method for processing request tokens. The method involves receiving request data and disclosure rules from the requester, classifying the request data into a plurality of progressively informative data classes, the plurality of progressively informative data classes comprising a first data class and a second data class, the second data class including information supplementary to the first data class, tokenizing the request data according to the plurality of progressively informative data classes to generate a first request token configured for disclosure of at least the first data class, tokenizing the request data according to the plurality of progressively informative data classes to generate a second request token configured for disclosure of at least the second data class, and executing a cycle of evaluation of request tokens. Executing involves transmitting the first request token to the plurality of competing recipients, receiving responses to the first request token from the plurality of competing recipients, and where the responses to the first request token do not include acceptance of the first request token, and where disclosure of the second data class is enabled according to the disclosure rules, transmitting the second request token to the plurality of competing recipients.

In some embodiments, the disclosure rules designate a preferred recipient of the plurality of competing recipients, and the method for processing request tokens involves, prior to transmitting the first request token to the plurality of competing recipients, anonymizing the request data of personal identifying information, and the executing a cycle for evaluation of request tokens involves, where the responses to at least one of the first request token and the second request token include acceptance, deanonymizing the request data to include personal identifying information, and providing a right of last preferred offer to the preferred recipient.

In some embodiments, the server is configured to execute the cycle of evaluation of request tokens upon request of the preferred recipient, and the receiving request data and disclosure rules from the requester includes routing the request data and disclosure rules through the preferred recipient.

In some embodiments, the system further comprises a third party in communication with the server via the computer network, the server is configured to execute the cycle of evaluation of request tokens upon request of the third party, and the receiving request data and disclosure rules from the requester includes routing the request data and disclosure rules through the third party.

In some embodiments, the method for processing request tokens involves the request data of personal identifying information.

According to another aspect of the disclosure, a method for processing request tokens involves receiving request data and disclosure rules, classifying the request data into a plurality of progressively informative data classes, the plurality of progressively informative data classes comprising a first data class and a second data class, the second data class including information supplementary to the first data class, tokenizing the request data according to the plurality of progressively informative data classes to generate at least one request token configured for disclosure of the first data class, transmitting the at least one request token configured for disclosure of the first data class to a least one competing recipient, receiving responses to the at least one request token configured for disclosure of the first data class from the at least one competing recipient, and, where the responses do not include acceptance of the at least one request token configured for disclosure of the first data class, and where disclosure of the second data class is enabled according to the disclosure rules, transmitting at least one request token configured for disclosure of the second data class to the at least one competing recipient.

In some embodiments, the disclosure rules designate a preferred recipient of the at least one competing recipient, and the method involves, prior to transmitting the at least one request token configured for disclosure of the first data class to at least one competing recipient, anonymizing the request data of personal identifying information, and, where the responses include acceptance of the request token, deanonymizing the request data to include personal identifying information, and providing a right of last preferred offer to the preferred recipient.

In some embodiments, the method involves anonymizing the request data of personal identifying information.

In some embodiments, the method involves harmonizing the request data to enable each of the at least one competing recipients to evaluate the request token.

In some embodiments, the method involves formatting the request data to be compatible with technical submission requirements of each of the at least one competing recipient.

Other features and advantages are described below.

### BRIEF DESCRIPTION OF THE DRAWINGS

Embodiments of the present disclosure will now be described, by way of example only, with reference to the attached Figures, wherein:

FIG. 1 is a schematic diagram of a system for processing a request token;

FIG. 2 is a functional block diagram of a server configured to execute a method for processing a request token;

FIG. 3 is a schematic diagram of a set of progressively informative data classes;

FIG. 4 is a flowchart of a method for processing a request token;

FIG. 5 is a schematic diagram of a system for processing request tokens;

FIG. 6 is a functional block diagram of a server configured to execute a method for processing request tokens;

FIG. 7 is a schematic diagram of another system for processing a request token;

FIG. 8 is a functional block diagram of another server configured to execute a method for processing a request token;

FIG. 9 is a schematic diagram of another set of progressively informative data classes;

FIG. 10 is a flowchart of another method for processing a request token;

FIG. 11 is a flowchart of a method for gathering request data;

FIG. 12 is a flowchart of a method for gathering disclosure rules;

FIG. 13 is a schematic diagram of the system for processing a request token of FIG. 7 showing transmission of request data and disclosure rules;

FIG. 14 is a flowchart of a method for executing a first cycle of evaluating a request token;

FIG. 15 is a flowchart of a method for executing a second cycle of evaluating a request token;

FIG. 16 is a flowchart of a method for executing a third cycle of evaluating a request token;

FIG. 17 is a schematic diagram of the system for processing a request token of FIG. 7 showing transmission and receipt of a request token, request data, and disclosure rules;

FIG. 18 is a flowchart of another method for executing a cycle of evaluation of a request token; and

FIG. 19 is a flowchart of yet another method for executing a cycle of evaluation of a request token.

### DETAILED DESCRIPTION

This disclosure relates to the transmission and processing of digital information, and in particular to a system for processing request tokens. The system includes a requester, a plurality of competing recipients, and a server configured to execute a method for processing the request tokens.

The request tokens include data that is relevant for the evaluation of a transaction between the requester and the plurality of competing recipients. The data are classified into a series of progressively informative data classes, each successive data class including additional information relevant to the transaction being evaluated. Data that is classified according to the data classes can be included in one request token configured to selectively disclose certain data classes while withholding others, or the data can be divided among a plurality of request tokens.

The request tokens can be used in a series of successive request rounds between the requester and competing recipients. At each request round, a request token is transmitted to the recipients, whereby a data class is disclosed. In the subsequent request round, a request token can again be transmitted to the recipients, whereby a new data class is disclosed, providing additional information to the plurality of competing recipients, allowing each recipient to perform additional analysis on the data and update its evaluation of the transaction, while retaining the privacy of the discloser and reducing informational asymmetry between the parties.

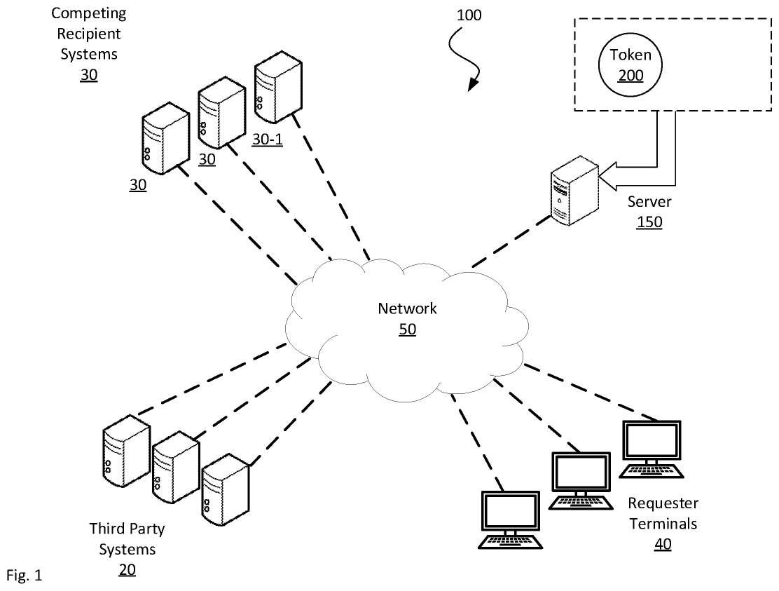

Other features and advantages of the system are described more fully below, where non-limiting embodiments of the system are described with reference to the following Figures. For convenience, reference numerals may be repeated (with or without an offset) to indicate analogous components or features. As an example of a repeated reference numeral without an offset, competing recipient systems 30 in system 100 of FIG. 1 are repeated as competing recipient systems 30 in system 100A as an analogous component. As an example of a repeated reference numeral with an offset, server 150 in system 100 in FIG. 1 is repeated as server 150A an analogous component having the differences described.

FIG. 1 is a schematic diagram of a system 100 for processing a request token 200, according to a non-limiting embodiment. System 100 includes competing recipient systems 30, third party systems 20, requester terminals 40, and server 150, in communication over one or more computer networks, indicated as network 50.

The competing recipient systems 30 and third party systems 20 include a computing device running a user or server application with storage, communication, and processing means. Requester terminals 40 include a computing device running a user application with storage, communication, and processing means. Server 150 includes a computing device running a server application with a storage device, communication device, and processor.

In some embodiments, requester terminals 40 may include a smart phone running an operating system such as, for example, Android®, iOS®, Windows® mobile, BB 10, or similar. In other embodiments, the wireless device 130 includes a tablet computer, a personal digital assistant (PDA), computer, or similar.

The network 50 can include the internet, a Wi-Fi network, a local-area network, a wide-area network (WAN), a wireless cellular data network, a virtual private network (VPN), a combination of such, and similar.

Although a single server 150 is described, it is understood that server 150 may refer to a combination of servers, such as in a cloud computing environment.

Server 150 stores a request token 200, which includes data that is relevant to a transaction being evaluated between a requester terminal 40 and the competing recipient systems 30.

Third party systems 20 include information provider systems which may provide information relevant to the transaction being evaluated upon request, and may include systems trusted to initiate evaluation of a transaction.

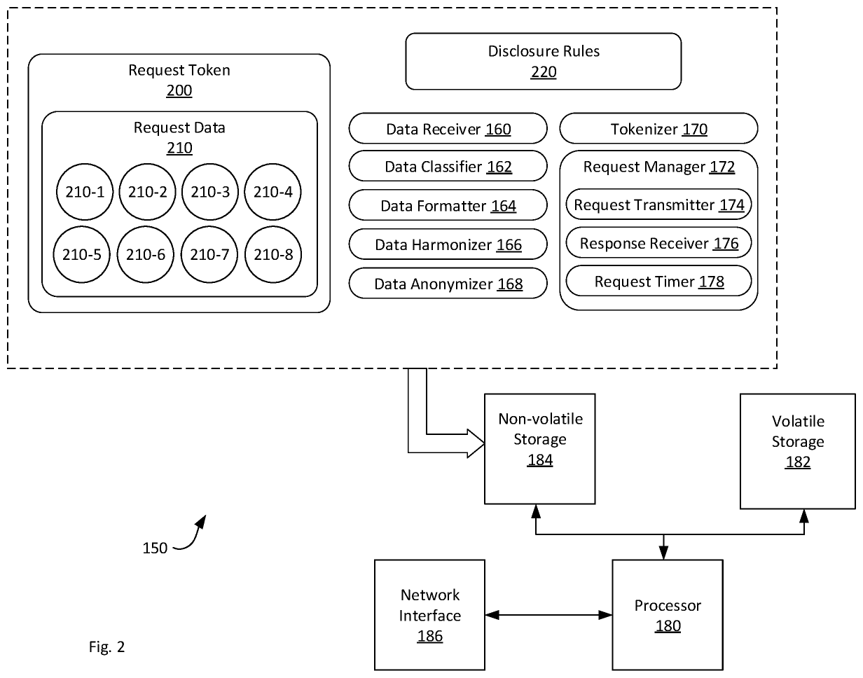

FIG. 2 is a block diagram of the functional components of server 150, according to a non-limiting embodiment. Server 150 includes a processor 180, network interface 186, volatile storage 182 and non-volatile storage 184. Non-volatile storage 184 provides a non-transitory computer-readable medium containing programming instructions for implementing disclosure rules 220 and the functional modules described below.

Although a single processor 180 is shown, the term “processor” as discussed herein refers to any quantity and combination of a processor, a central processing units (CPU), a microprocessor, a microcontroller, a field-programmable gate array (FPGA), and similar. The processor 180 is capable of processing large volumes of data and capable of processing data in a short period of time in a manner which enables the processing of request tokens discussed in this disclosure. As will be seen below, the processor 180 is capable of processing transmission of request tokens and responses to request tokens from a plurality of competing recipients in successive request rounds automatically in a short period of time.

Volatile storage 182 may include random-access memory (RAM) or similar. Non-volatile storage 184 may include a hard drive, flash memory, and similar. Non-volatile storage 184 provides a non-transitory computer-readable medium containing programming instructions for performing a method of processing a request token or request tokens, as discussed in greater detail below.

Also stored on non-volatile storage 184 are several functional modules containing programming instructions, including a data receiver 160, a data classifier 162, a data formatter 164, a data harmonizer 166, a data anonymizer 168, a tokenizer 170, and a request manager 172, which includes a request transmitter 174, a response receiver 176, and a request timer 178.

Data receiver 160 is a program comprising programming instructions for receiving data from requester terminals 40 and third party systems 20 for inclusion into request token 200.

Data classifier 162 is a program comprising programming instructions for classifying the data received by data receiver 160 into progressively informative data classes.

Data formatter 164 is a program comprising programming instructions for formatting the data in request token 200 to be compatible with submission requirements of each of the plurality of competing recipients. For example, a competing recipient system 30 may prefer that request data 210 be presented to it in Extensible Markup Language (XML) format, whereas another competing recipient system 30 may prefer that request data 210 be presented to it in JavaScript Object Notation (JSON) format, and another competing recipient system 30 may prefer that the request be made through a fillable PDF file.

Data harmonizer 166 is a program comprising programming instructions for including sufficient data in the request token 200 to enable each of the plurality of competing recipients to evaluate the transaction. Each competing recipient system 30 may require different information in order to evaluate any given transaction. Thus, the data harmonizer 166 ensures that the request token 200 contains sufficient information required for all relevant competing recipient systems 30 to evaluate the request by, for example, prompting a requester terminal 40 to provide the required information. In some embodiments, the prompts are generated by an artificial intelligence.

Data anonymizer 168 is a program comprising programming instructions for removing personal identifying information from the data in request token 200.

Tokenizer 170 is a program comprising programming instructions for assembling the data relevant to the transaction being evaluated which is received by data receiver 160, classified by data classifier 162, formatted by data formatter 164, harmonized by data harmonizer 166 and anonymized by data anonymizer 168, and generating a request token 200 therefrom.

Request manager 172 is a program comprising programming instructions for managing transmission of request token 200, and responses thereto, in successive request rounds between the requester terminals 40 and competing recipient systems 30. At each successive request round, a request token is transmitted to the recipients, whereby a data class is disclosed, and a response to evaluation of the transaction is received. Where the responses to the request token 200 do not include acceptance of the request token 200, a request token 200 may again be transmitted disclosing an additional data class in a subsequent cycle of evaluation of request token 200. The request manager 172 thereby executes cycles of evaluation of a request token 200.

The request manager 172 includes a request transmitter 174, a program comprising programming instructions for transmitting request token 200 to the competing recipient systems 30, a response receiver 176, a program comprising programming instructions for receiving responses to the request token 200. The request manager 172 includes a request timer 178, a program comprising programming instructions to provide time and duration information to request manager 172. For example, in certain steps of the request rounds, competing recipient systems 30 are requested to respond to a request within a specified timeframe. In some embodiments, a preferred competing recipient system 30-1 may be allocated more time to respond to a request.

In some embodiments, the request manager 172 may include logic to give preference to a preferred competing recipient system 30-1 (FIG. 1) a right of last preferred offer (ROLPO). In such cases, some data classes 230 may be disclosed to certain preferred competing recipient systems 30-1, while withholding such data from other competing recipient systems 30. In some embodiments, the preferred competing recipient 30-1 may be afforded a right of last offer which allows the preferred competing recipient system 30-1 to make an offer or adjust a previous offer, whether to match a competing offer, improve a previous offer, or otherwise amend its offer in response to the request token 200 offered by another competing recipient system 30.

Also stored on non-volatile storage 184 is request token 200, including a request data 210, comprising data 210-1 through 210-8. Data 210-1 through 210-8 each contain information which may be relevant to the transaction being evaluated. The data 210-1 through 210-8 are classified according to progressively informative data classes.

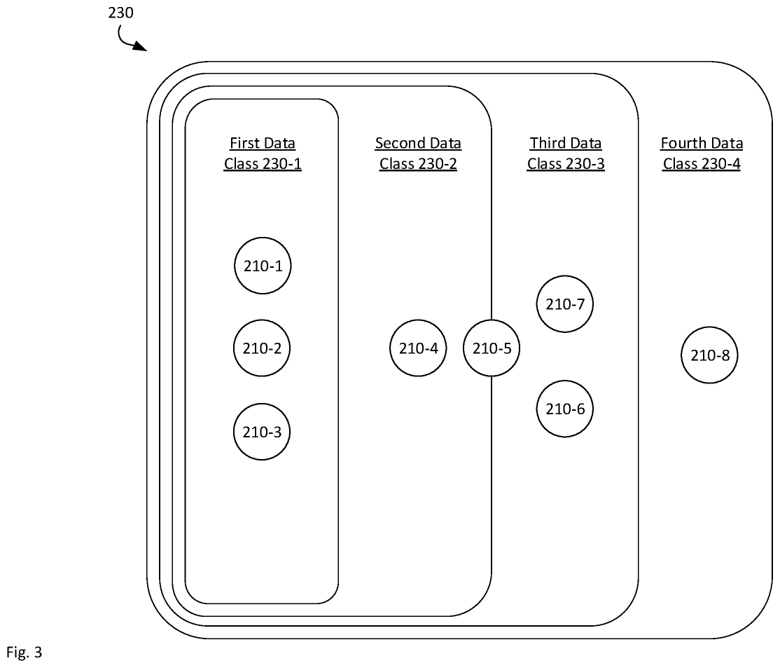

FIG. 3 is a schematic diagram of a data classes 230, according to a non-limiting embodiment. Data classes 230 are classified into a first data class 230-1, second data class 230-2, third data class 230-3, and fourth data class 230-4. Data 210-1 through 210-8 are classified according to data classes 230-1 through 230-4, where first data class 230-1 includes data 210-1, 210-2, and 210-3, second data class 230-2 includes data 210-4 and 210-5, third data class 230-3 includes data 210-5, 210-6, and 210-7, and fourth data class 230-4 includes data 210-8.

Examples of the contents of data 210-1 through 210-8 will be discussed below. Briefly, each data class 230-1 through 230-4 includes data relevant to the transaction being evaluated, each including additional relevant information.

In the present embodiment, the data classes overlap, in that the fourth data class 230-4 is indicated as including data classes 230-1, 230-2, and 230-3, and so forth. However, it is contemplated that in other embodiments the data classes may be divided distinctly, or only partially overlapping, provided that successive data classes include information supplementary to the other data classes.

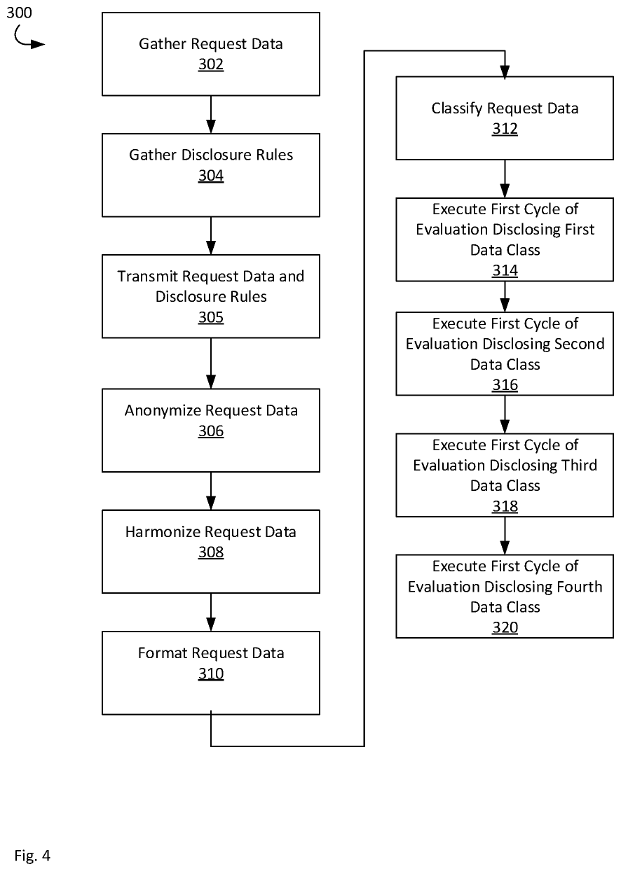

FIG. 4 is a flowchart showing a method 300 for processing a request token having progressively informative data classes, according to a non-limiting embodiment. The method 300 is one way in which the request token may be processed. It is to be emphasized, however, that the blocks of method 300 need not be performed in the exact sequence as shown. Further, the method 300 is described as performed by a system and device discussed herein, but this is not limiting and the method can alternatively be performed by other systems and/or devices.

At block 302, request data 210 is gathered. Request data 210 includes information relevant to the transaction being evaluated, examples of which will be discussed with reference to other embodiments below.

At block 304, disclosure rules 220 are gathered. The disclosure rules 220 include rules for when the request data 210, which is to be classified into progressively informative data classes 230, may or may not be disclosed to the competing recipient systems 30. For example, the disclosure rules 220 may specify that data classes 230-1 and 230-2 may be disclosed automatically, that the third data class 230-3 may be disclosed only upon further confirmation, and that the fourth data class 230-4 may not be disclosed at any time. Such disclosure rules 220 are considered in cycles of evaluation of the request token 200, such as blocks 314 through 320 below.

At block 305, the gathered request data 210 and disclosure rules 220 are transmitted to server 150 for further processing.

At block 306, the request data 210 is anonymized. The request data 210 is cleansed of any personal identifying information. Thus, in evaluation of the transaction, the request token 200 serves as the unique identifier for a user of a requester terminal 40, without necessarily requiring the user to divulge personal identifying information.

At block 308, the request data 210 is harmonized. The request data 210 is harmonized so as to include sufficient data in the request token 200 to enable each of the competing recipient systems 30 to evaluate the transaction.

At block 310, the request data 210 is formatted. The request data 210 is formatted is formatted so as to be compatible with the technical submission requirements of each competing recipient system 30.

At block 312, the request data 210 is classified into progressively informative data classes 230. As in the embodiment shown in FIG. 3, each data 210-1 through 210-8 may be classified according to a data class 230-1 through 230-4, where each data class includes information supplementary to another data class. The request token 200 is initially configured to disclose the first data class 230-1.

At block 314, a first cycle of evaluation of the request token 200 is executed. The request token 200 is transmitted to the competing recipient systems 30, disclosing the first data class 230-1. The competing recipient systems 30 may evaluate the transaction based on this information provided, and a response is received at server 150. Where the responses do not include acceptance of the request token 200, and where the disclosure rules 220 stipulate that the second data class 230-2 may be disclosed, block 316 may be executed where the request token 200 is reconfigured to disclose the second data class 230-2.

At block 316, a second cycle of evaluation of the request token 200 is executed. As in block 314, the request token 200 is transmitted to the competing recipient systems 30, now disclosing the second data class 230-2. Where no response accepting the request token 200 is received at server 150, and where disclosure rules 220 stipulate that the third data class 230-3 may be disclosed, block 318 may be executed where the request token 200 is reconfigured to disclose the third data class 230-3.

At block 318, a third cycle of evaluation of the request token 200 is executed. As in block 314 and 316, the request token 200 is transmitted to the competing recipient systems 30, now disclosing the third data class 230-3. Where no response accepting the request token 200 is received at server 150, and where disclosure rules stipulate that the fourth data class 230-4 may be disclosed, block 320 may be executed where the request token 200 is reconfigured to disclose the fourth data class 230-4.

At block 320, a fourth cycle of evaluation of the request token 200 is executed. As in block 314, 316, and 318, the request token 200 is transmitted to the competing recipient systems 30, now disclosing the fourth data class 230-4. Where no response accepting the request token 200 is received at server 150, the request token 200 may be rejected.

In some embodiments, the disclosure rules 220 may include rules stipulating that some data classes 230 may be disclosed to certain preferred competing recipient systems 30-1 (FIG. 1), while withholding such data from other competing recipient systems 30. In some embodiments, the preferred competing recipient system 30-1 may be afforded a right of last offer which allows the preferred competing recipient system 30-1 to make an offer or adjust a previous offer, whether to match the competing offer, improve its previous offer, or otherwise amend its offer in response the request token 200 offered by another competing recipient system 30.

It thus can be seen that additional cycles of evaluation of the transaction, or fewer cycles of evaluation of the transaction, may be included in the method 300, depending on the division of the data classes 230.

Some of the blocks 314 through 320, where cycles of evaluation of the transaction are executed, may be executed in automatically in succession. Where all of the request data 210 is available to proceed through each of the blocks 314 through 320, the blocks may be performed at a speed limited only by the network and devices of system 100. Thus, the speed and efficiency of evaluation of the transaction may be enhanced. Where portions of the request data 210 required to perform blocks 314 through 320 are not immediately available at the initiation of block 314, the necessary data may be acquired through system 100 between requester terminals 40, competing recipient systems 30, and third party systems 20.

Further, it can be seen that the information in request data 210 may be disclosed progressively, according to the disclosure rules 220, as stipulated by the users of requester terminals 40. A transaction may thereby be completed between a user of a requester terminal 40 and a competing recipient system 30 without the user of the requester terminal divulging more information than necessary. A user of a requester terminal 40 may thereby make a plurality of requests to a plurality of competing recipient systems 30 in a manner which retains the power of the information disclosed therein with the users of requester terminals 40.

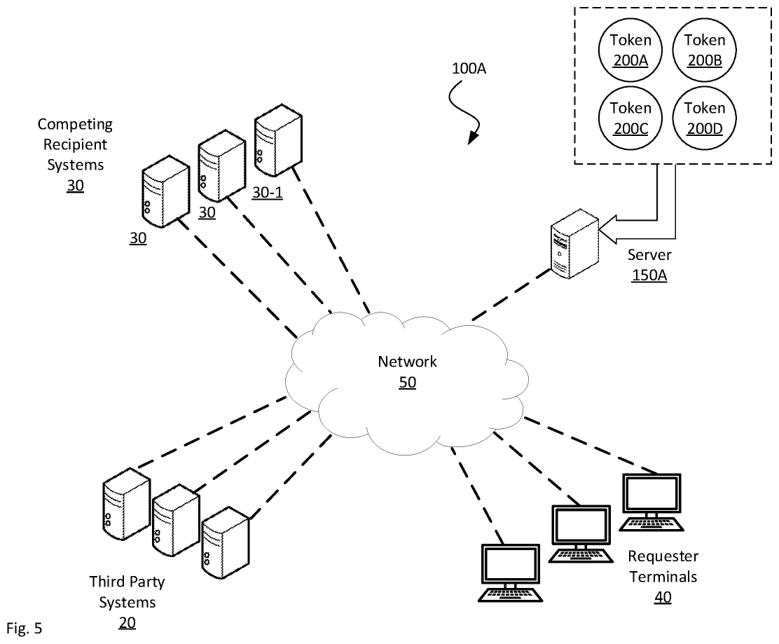

FIG. 5 is a schematic diagram of a system 100A for processing request tokens, according to a non-limiting embodiment. For description of competing recipient systems 30, third party systems 20, requester terminals 40, and network 50, reference may be had to FIG. 1.

For description of server 150A, reference may be had to FIG. 1 with respect to server 150. In the present embodiment, server 150A stores a plurality of request tokens 200A, 200B, 200C, and 200D, which include data that is relevant to a transaction being evaluated between a requester terminal 40 and the competing recipient systems 30, and which is supplementary to the other request tokens.

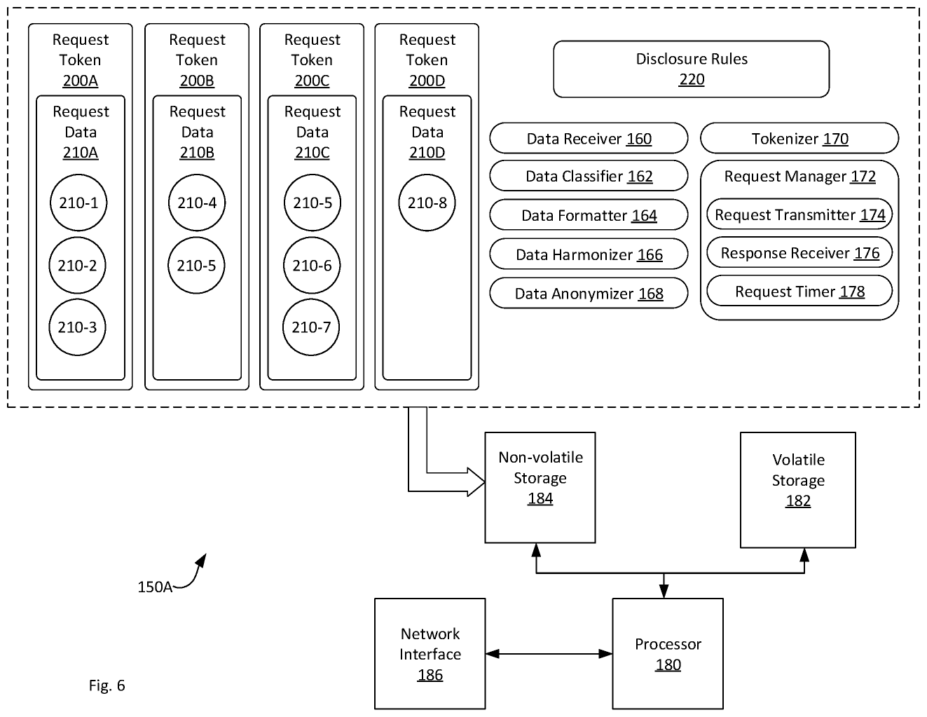

FIG. 6 is a block diagram of the functional components of server 150A, according to a non-limiting embodiment. For description of processor 180, volatile storage 182, network interface 186, non-volatile storage 184, disclosure rules 220, data receiver 160, data classifier 162, data formatter 164, data harmonizer 166, data anonymizer 168, tokenizer 170, request manager 172, request transmitter 174, a response receiver 176, and request timer 178, reference may be had to FIG. 2.

In the present embodiment, request tokens 200A, 200B, 200C, 200D include request data 210A, 210B, 210C, and 210D, respectively, comprising data 210-1 through 210-8. Data 210-1 through 210-8 each contain information which may be relevant to the transaction being evaluated. The data 210-1 through 210-8 are classified according to progressively informative data classes 230, in the manner set out in FIG. 3. Each request token 200A, 200B, 200C, and 200D, thus corresponds to a data class 230-1, 230-2, 230-3, 230-4, respectively.

A method for processing a request token, as set out in method 300 (FIG. 4), may be performed using request tokens 200A, 200B, 200C, 200D, where at block 314 request token 200A is transmitted to the competing recipient systems 30, at block 316 request token 200B, is transmitted, and so forth.

This, it can be seen that that the request data 210 may be classified according to progressively informative data classes 230, and may be arbitrarily distributed across one or a plurality of request tokens. Where the request data 210 is distributed across one request token, the request token is configured for selective disclosure of data classes 230 according to the disclosure rules 220. Where the request data 210 is distributed across a plurality of request tokens, request tokens are selectively transmitted according to the disclosure rules 220. Further, a combination of such implementations is contemplated, where a plurality of request tokens, each being configured for selective disclosure, are used.

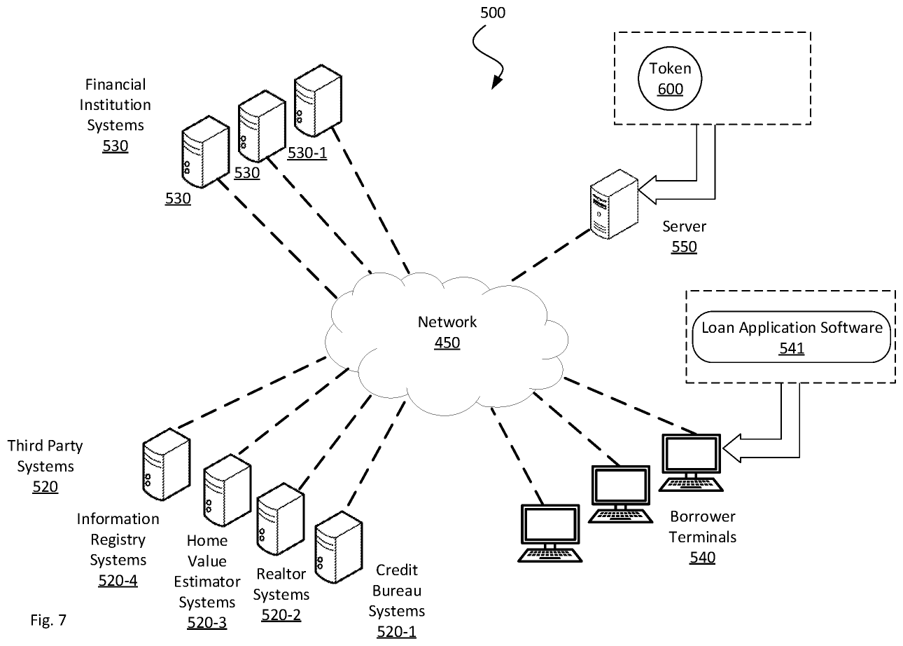

FIG. 7 is a schematic diagram of a system 500 for processing a request token 600, according to a non-limiting embodiment. System 700 includes financial institution systems 530, third party systems 520, which include information provider systems such as include credit bureau systems 520-1, realtor systems 520-2, home value estimator systems 520-3, and information registry systems 520-4, borrower terminals 540, and a server 550, in communication over one or more computer networks, indicated as network 450. Third party systems 520 may also include other systems trusted to initiate evaluation of a transaction.

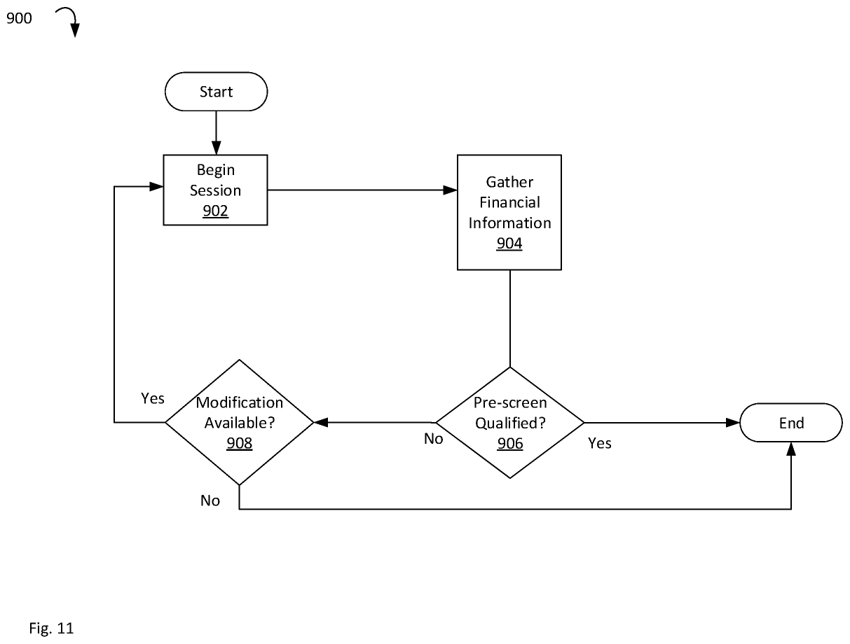

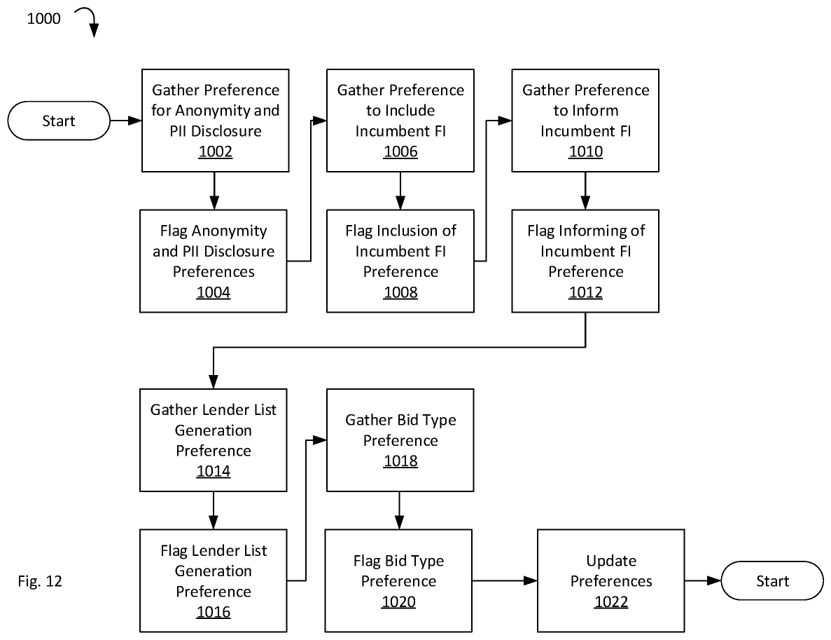

For the functional components of financial institution systems 530, third party systems 520, borrower terminals 540, server 550, and network 450, reference may be had to competing recipient systems 30, information provider systems 20, requester terminals 40, server 150, and network 50, respectively, in FIG. 1. The borrower terminals 540 include a loan application software 541 containing programming instructions for gathering request data and disclosure rules from a user of the borrower terminal 540, discussed in greater detail below with respect to FIGS. 11 and 12.

Credit bureau systems 520-1 make available credit bureau report data describing financial information regarding users operating the borrower terminals 540, accessible over network 450, upon request.

Realtor systems 520-2 make available housing information which a user at a borrower terminal 540 may wish to purchase, accessible over network 450, upon request.

Home value estimator systems 520-3 make available estimates for housing which a user at a borrower terminal 540 may wish to purchase, or sell, available over network 450, upon request. Home value estimator systems 520-3 can be used to provide home value estimate data to the server 550. Such data represents home values that borrowers can use to guide their decision making. Such data may be generated by algorithms or artificial intelligence by one or more third parties remote from the server 550. Additionally or alternatively, one of the home value estimator systems 520-3 is controlled by the server 550 and/or the operator of the server 550.

Information registry systems 520-4 make available personal information associated with a user's identification documentation upon request. For example, information registry systems 520-4 may include a driver's license registry system where a user's personal information may be obtained using the user's driver's license number upon request. Other examples of information registry systems 520-4 include tax authority systems. Information registry systems 520-4 may be used to assist in automatically gathering information relating to the borrower, discussed in greater detail below.

Server 550 stores a request token 600, which includes data that is relevant to a loan transaction being evaluated between a borrower terminal 540 and the financial institution systems 530. Financial institution systems 530 consider loan requests from a user at a borrower terminal 540 upon receiving a request token 600. The request token 600 contains the required financial profile information and loan profile information needed for the financial institution system 530 to evaluate the transaction, and to determine whether to make an offer to the user of borrower terminal 540 for a loan. It is to be understood that where the term financial institution system or financial institution is used, the term may refer to a financial institution as a whole, any department of the financial institution, or any subsidiaries or affiliates of the financial institution, as the case may be.

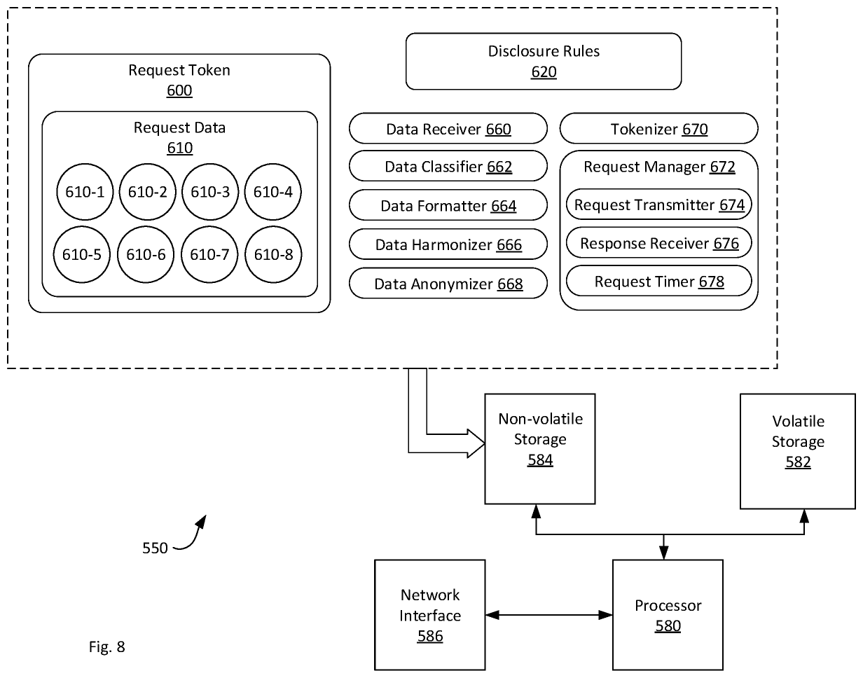

FIG. 8 is a block diagram of the functional components of server 550, according to a non-limiting embodiment. For description of processor 580, volatile storage 582, network interface 586, non-volatile storage 584, disclosure rules 620, data receiver 660, data classifier 662, data formatter 664, data harmonizer 666, data anonymizer 668, tokenizer 170, request manager 672, request transmitter 674, a response receiver 676, and request timer 678, reference may be had to analogous components of server 150 in FIG. 2.

Stored on non-volatile storage 584 is request token 600, including a request data 610, comprising data 610-1 through 610-8. Data 610-1 through 610-8 each contain information which may be relevant to the loan transaction being evaluated. The data 610-1 through 610-8 are classified according to progressively informative data classes.

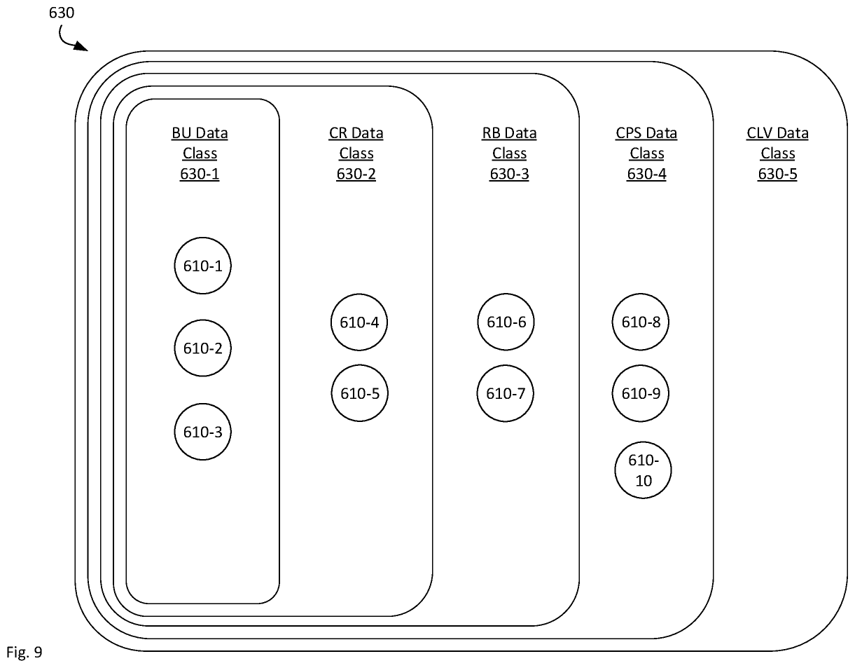

FIG. 9 is a schematic diagram of a data classes 630, according to a non-limiting embodiment. Data classes 630 are divided into a Basic Underwriting and Adjudication data class (BU data class 630-1), a Customer Relationship-Based data class (CR data class 630-2), a Risk-Based Segmentation data class (RB data class 630-3), a Customer Price Sensitivity Segmentation data class (CP data class 630-4), and a Customer Lifetime Value Based Segmentation data class (CLV data class 630-5). The data classes 630 is one way of classifying the request data 610, but it is contemplated that in other embodiments the request data 610 may be classified in other ways. Briefly, each data class 630-1 through 630-5 includes data relevant to the loan transaction being evaluated, each generally including progressively informative additional relevant information.

The BU data class 630-1 includes basic information required by most financial institutions evaluating a loan transaction. In some embodiments, BU data class 630-1 includes loan parameters 610-1, borrower financial information 610-2, and anonymized property loan details 610-3.

Loan parameters 610-1 includes the borrower's credit score, the type of loan (home equity, revolving, first mortgage, etc.), product characteristics the borrower is seeking, product features the borrower is seeking (fixed-rate loan, floating-rate loan, payment frequency, etc.), the purpose of the loan, the borrower's income, the loan amount, the amount owing, the principal and interest owing, and the interest-only status of the loan. It is emphasized, however, that a portion of the information in loan parameters 610-1 may be provided by way of a prescreening process, whether automatic or manual entry, with the remainder of loan parameters 610-1 being gathered at a later time. For example, in some embodiments, the user's name, email, type of home loan sought, postal code, loan amount, and amount owing, may be obtained in a pre-screening process. Further, a portion of the information gathered in the pre-screening process may be gathered automatically using a user's driver's license number, or from other identification documents, including scanned identification documents, and obtaining information associated with the identification documents from third party systems 520, such as information registry systems 520-4.

Borrower financial information 610-2 includes expenses, net assets, net liabilities, proof of income, monthly payment amounts, guarantors, the repayment horizon, the preferred term, and the borrower's annual income.

Anonymized property loan details 610-3 includes the property postal code, the down payment amount, the down payment source, date for when funds are needed, property appraisal value, main bank information, prospective property details, the property address, location, taxes, size, the borrower's estimate of the value of the property, the expected loan amount, the expected closing costs, prepayment options, property municipality, and expected legal fees. Anonymized property loan details 610-3 may also include calculations and estimates, such as net asset value, monthly payment, term, amortization, or the loan to value ratio. Anonymized property loan details 610-3 may also include estimated closing costs, including land transfer costs, sales tax, legal fees, title search cost, or title insurance cost. Anonymized property loan details 610-3 may include service ratios, including total debt service ratio (TDSR) and gross debt service ratio (GDSR). Anonymized property loan details 610-3 may also include the digital home value (DHV) estimate.

The CR data class 630-2 includes additional customer relationship information relevant for financial institutions evaluating a loan transaction. In some embodiments, CR data class 630-2 includes anonymized main financial institution information (AMFII 610-4) and anonymized persona profile data (APPD 610-5), as well as the information in BU data class 630-1.

AMFII 610-4 includes information about the borrower's main financial institution, the depth of the borrower's relationship with its main financial institution, what products the borrower has with its main financial institution, a customer satisfaction assessment, and flight risk assessment information.

APPD 610-5 includes whether the borrower is a first time home buyer, whether the borrower is an investor, whether the borrower is a sophisticated borrower, whether the borrower wants to shop around, whether the borrower needs the loan quickly, whether the property is intended to be a rental property, whether the borrower is new to the jurisdiction in which the property is located, whether the borrower is refinancing, and whether the borrower is undergoing debt consolidation.

The RB data class 630-3 includes information relevant to the risk associated with the loan transaction being evaluated. RB data class 630-3 includes anonymized employment in formation (AEI 610-6) financial institution internal models and scores 610-7, as well as the information in BU data class 630-1 and CR data class 630-2.

AEI 610-6 includes the length of the borrower's employment, whether the borrower is self-employed, any co-borrower information, the sector of the borrower's employment, and the borrower's bankruptcy navigator index (BNI) indicator.

Financial institution internal models and scores 610-7 may calculate the risk associated with a particular loan or borrower.

The CP data class 630-4 includes information relevant for a financial institution adjusting its loan pricing in the evaluation of a loan transaction. The CP data class 630-4 includes anonymized customer price sensitivity information (ACPSI 610-8), internal financial institution price sensitivity indicators 610-9, personal identifying information (PII 610-10), as well as the information in BU data class 630-1, CR data class 630-2, and RB data class 630-3.

ACPSI 610-8 includes price elasticity indicators, the borrower's fixed or variable rate selection, whether the borrower had any questions about fees and the rate at which the borrower plans to pay down the load.

A financial institution may calculate its own internal price sensitivity indicators 610-9.

PII 610-10 includes the borrower's name, street address, postal code, email, driver's license information, date of birth, gender, height, employer, and phone number.

The CLV data class 630-5 includes information relevant to the lifetime of the customer which may be particularly relevant to a preferred financial institution system 530-1, such as an incumbent financial institution system, and includes personal identifying information of the borrower. The CLV data class 630-5 may include all of the information in the CP data class 630-4. Thus, while the CLV data class 630-5 may not be progressively informative relative to the CP data class 630-4, the CLV data class 630-5 may be disclosed at a different stage of the loan evaluation process, such as where the borrower's personal identifying information is to be deanonymized to reveal the borrower's identity. For example, the CLV data class 630-5 may be disclosed only to a preferred (incumbent) financial institution system 530-1, and only where a right of last offer is to be presented to the preferred financial institution 530-1, where the incumbent financial institution system 530-1 may include the borrower's identity, having been deanonymized, into its evaluation of the loan transaction.

It is emphasized that the information in request data 610 is exemplary only. Request data 610 may include additional, less, or other information relevant to the loan transaction being evaluated. Further, it is emphasized that the classification of request data 610 is exemplary only, and that the request data 610 may be classified in other ways.

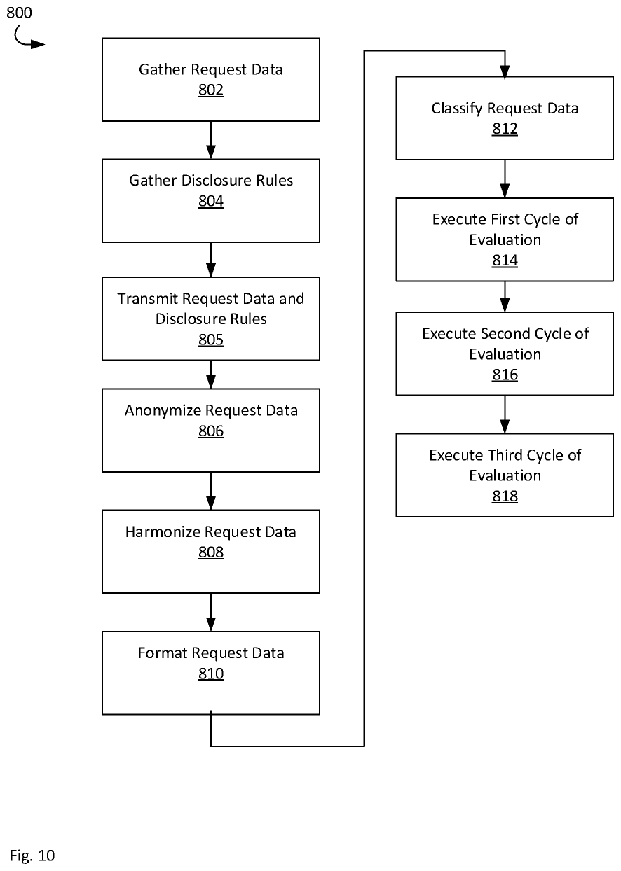

FIG. 10 is a flowchart showing a method 800 for processing a request token having progressively informative data classes, according to a non-limiting embodiment. The method 800 is one way in which the request token may be processed. It is to be emphasized, however, that the blocks of method 800 need not be performed in the exact sequence as shown. Further, the method 800 is described as performed by a system and device discussed herein, but this is not limiting and the method can alternatively be performed by other systems and/or devices.

At block 802, request data 610 is gathered. Request data 610 includes information relevant to the loan transaction being evaluated. Request data 610 may be gathered as set out in method 900, in FIG. 11, below.

At block 804, disclosure rules 620 are gathered. The disclosure rules 620 include rules for when the request data 610, which is to be classified into progressively informative data classes 630, may or may not be disclosed to the financial institution systems 530. For example, the disclosure rules 620 may specify that data classes 630-1 and 630-2 may be disclosed automatically, that data class 630-3 may be disclosed only upon further confirmation, that data class 630-4 may not be disclosed at any time, and that data class 630-5 may only be disclosed to a preferred financial institution system 530-1 pursuant to a right of last offer. Request data 610 may be gathered as set out in method 1000, in FIG. 12, below.

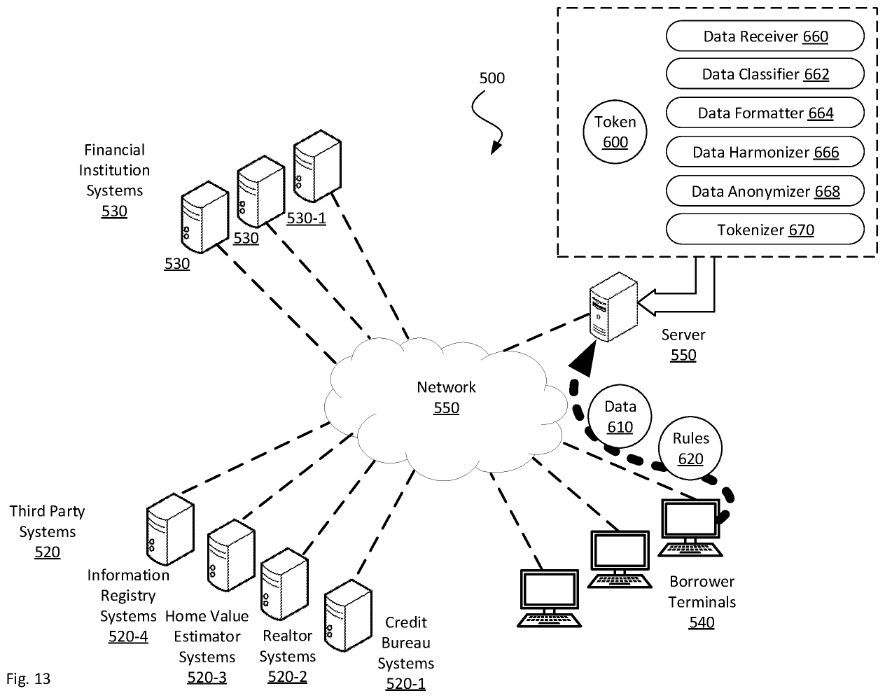

At block 805, the gathered request data 610 and disclosure rules 620 are transmitted to server 550 for further processing, as indicated in FIG. 13 below.

At block 806, the request data 610 is anonymized. Thus, the request data 610 is divided into PII 610-10, and included only in data classes 630-4, 630-5. Thus, during a portion of the evaluation of the loan transaction, the request token 600 serves as the unique identifier for a user of a borrower terminal 540, without necessarily requiring the user to divulge PII 610-10. In the case where a preferred financial institution system 530-1 is designated, a benefit of the borrower remaining anonymized to its preferred financial institution system 530-1 is that the institution may treat the borrower as a new customer and may compete more aggressively under the impression that it is winning the business of a new client. A benefit of the borrower identifying itself to its preferred financial institution system 530-1 is that the institution may be informed that the borrower is considering competitor offers, and thus may compete more aggressively to retain the client's business.

At block 808, the request data 610 is harmonized. The request data 610 is harmonized so as to include sufficient data in the request token 600 to enable each of the financial institution systems 530 to evaluate the transaction.

At block 810, the request data 610 is formatted. The request data 610 is formatted is formatted so as to be compatible with the technical submission requirements of each of the financial institution systems 530.

At block 812, the request data 610 is classified into progressively informative data classes 630. As in the embodiment shown in FIG. 9, each data 610-1 through 610-10 may be classified according to a data class 630-1 through 630-5. The request token 600 is initially configured to disclose the BU data class 630-1 and CR data class 630-2.

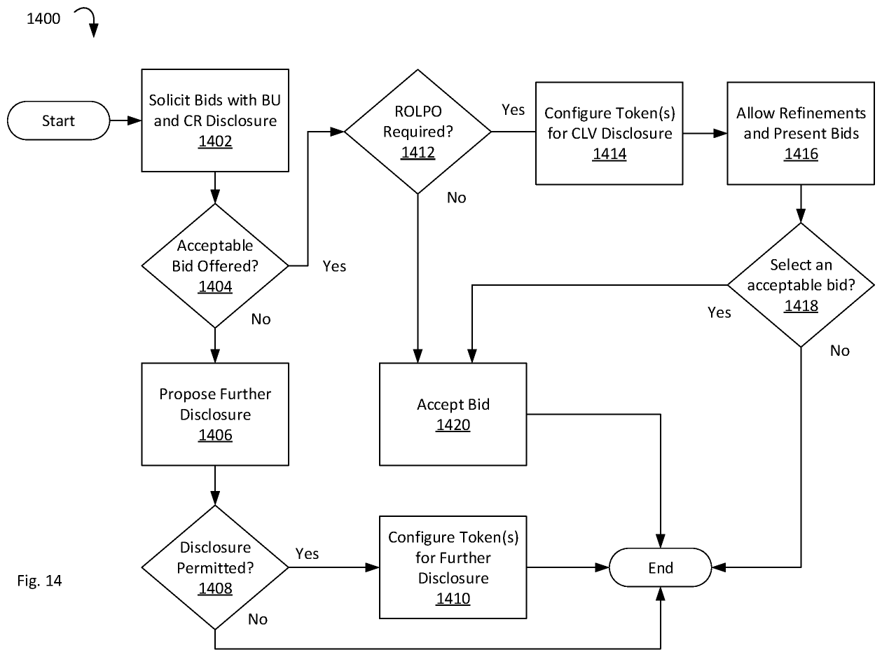

At block 814, a first cycle of evaluation of the request token 600 is executed. The request token 600 is transmitted to the financial institution systems 530, disclosing the BU data class 630-1 and CR data class 630-2. The financial institution systems 530 may evaluate the transaction based on this information provided, and a response is received at server 550. Where the responses do not include acceptance of the request token 600, and where the disclosure rules 620 stipulate that the RB data class 630-3 may be disclosed, block 816 may be executed where the request token 600 is reconfigured to disclose the RB data class 630-3. The first cycle of evaluation may proceed in the manner set out in FIG. 14, below.

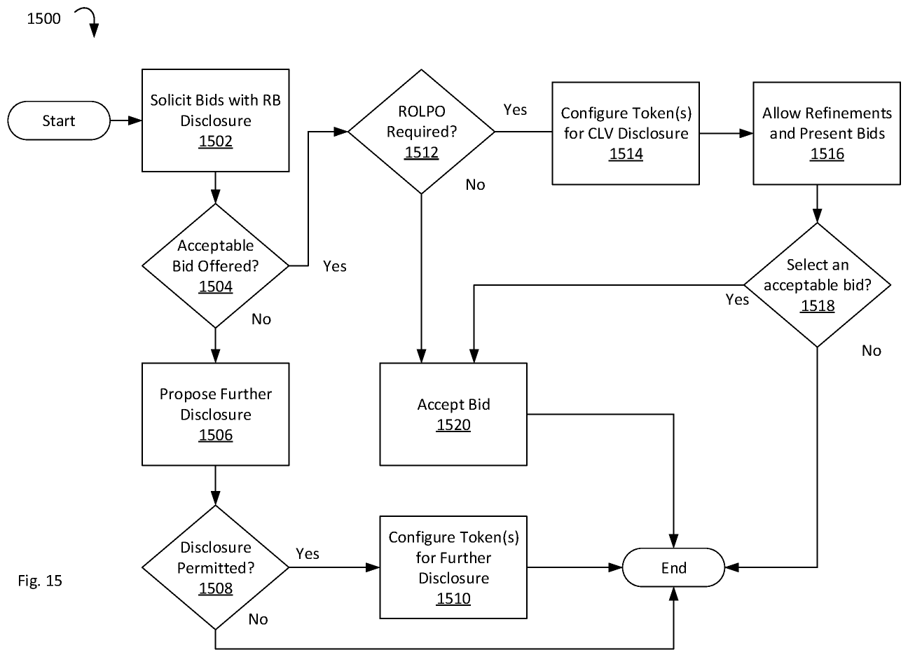

At block 816, a second cycle of evaluation of the request token 600 is executed. As in block 814, the request token 600 is transmitted to the financial institution systems 530, now disclosing the CR data class 630-3. Where no response accepting the request token 600 is received at server 550, and where disclosure rules 620 stipulate that the CP data class 630-4 may be disclosed, block 818 may be executed where the request token 200 is reconfigured to disclose the CP data class 630-4. The second cycle of evaluation may proceed in the manner set out in FIG. 15, below.

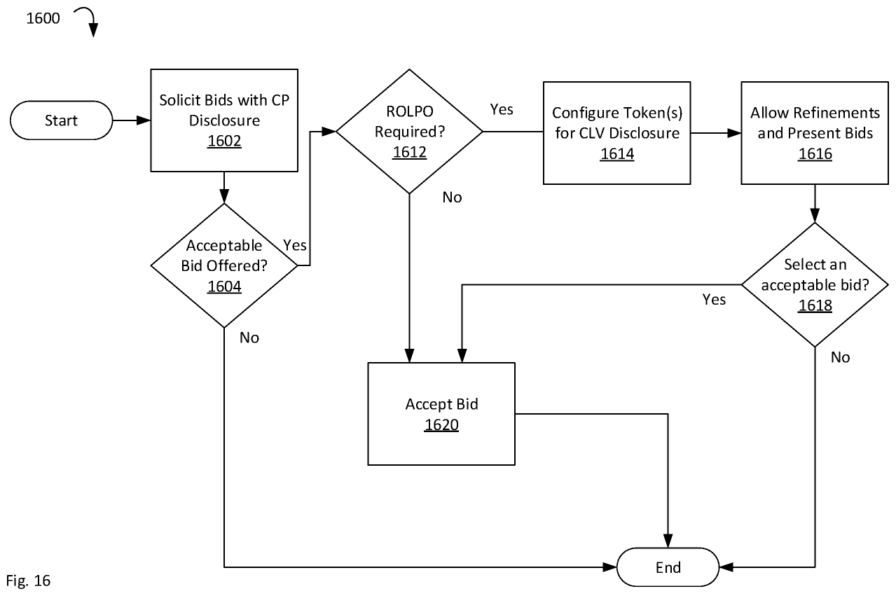

At block 818, a third cycle of evaluation of the request token 600 is executed. As in block 814 and 816, the request token 600 is transmitted to the financial institution systems 530, now disclosing the CP data class 630-4. Where no response accepting the request token 600 is received at server 550, the request token 600 may be rejected. The first cycle of evaluation may proceed in the manner set out in FIG. 16, below.

In some embodiments, the disclosure rules 620 may include rules stipulating that some data classes 630 may be disclosed to certain financial institution systems 530, referred to as a preferred financial institution system 530-1 (FIG. 7), while withholding such data from other financial institution systems 530. In some embodiments, the preferred financial institution systems 530-1 may be afforded a right of last offer which allows the preferred financial institution systems 530-1 to make an offer or adjust a previous offer, whether to match the competing offer, improve its previous offer, or otherwise amend its offer in response to the request token 600 offered by another financial institution system 530.

It thus can be seen that additional cycles of evaluation of the transaction, or fewer cycles of evaluation of the transaction, may be included in the method 800, depending on the division of the data classes 630.

Some of the blocks 814 through 818, where cycles of evaluation of the transaction are executed, may be executed in automatically in succession. Where all of the request data 610 is available to proceed through each of the blocks 814 through 818, the blocks may be performed at a speed limited only by the network and devices of system 500. Thus, the speed and efficiency of evaluation of the transaction may be enhanced. Where portions of the request data 610 required to perform blocks 814 through 818 are not immediately available at the initiation of block 814, the necessary data may be acquired through system 500 between borrower terminals 540, financial institution systems 530, and third party systems 520.

Further, it can be seen that the information in request data 610 may be disclosed progressively, according to the disclosure rules 620, as stipulated by the users of borrower terminals 540. A transaction may thereby be completed between a user of a borrower terminal 540 and a financial institution system 530 without the user of the borrower terminal 540 divulging more information than necessary. A user of a borrower terminal 540 may thereby make a plurality of requests to a plurality of financial institution systems 530 in a manner which retains the power of the information disclosed therein with the users of borrower terminals 540.

FIG. 11 is a flowchart showing a method 900 for gathering request data, according to a non-limiting embodiment. The method 900 is one way in which request data may be gathered. It is to be emphasized, however, that the blocks of method 900 need not be performed in the exact sequence as shown. Further, the method 900 is described as performed by a system and device discussed herein, but this is not limiting and the method can alternatively be performed by other systems and/or devices.

Method 900 may be performed by a user at a borrower terminal 540 running a session of loan application software 541. Generally, the information may be gathered by prompting the user with questions to obtain information. However, the sequence of questions asked and information gathered may vary to suit the needs of a particular transaction, borrower, or competing financial institution system 530. For example, in some embodiments, the loan application software 541 may initially gather personal information required for use of the loan application software 541 before continuing to gather additional request data 610 at a later time. Further, in some embodiments, only a portion of request data 610 may be provided in a first round of information gathering, while additional information may be gathered between successive rounds of evaluation of a request token 600. Further, default options to such questions may be provided for speed and convenience of the user. Answers to questions may selected by drop down menus, tick boxes, or other data entry mechanisms. Further, some information may be obtained automatically, such as, for example, personal information from information registry systems 520-4 using a user's driver's license number, or from other identification documents, including scanned identification documents.

At block 902, a session of loan application software 541 begins at a borrower terminal 540. A user accepts a terms-of-use, privacy policy, and consents to credit bureau information disclosure. The user provides contact information, which may include PII 610-10, and a credit report, which is verified by credit bureau systems 520-1.

At block 904, financial information is gathered from the user of borrower terminal 540. In some embodiments, the financial information gathered can include information included in data classes 630-1 through 630-5. In other embodiments, the financial information can include a subset of the data classes 630-1 through 630-5, at a minimum required to initiate a loan request. Where a portion of information required for executing cycles of evaluation of the loan transaction is omitted, the omitted information may be gathered between cycles of evaluation of the loan transaction. For example, only information in data classes 630-1 and 630-2 may be gathered initially, whereas information in data class 630-3 may be gathered upon request between second and third cycles of evaluation of the loan request. A timer may be provided for gathering of such omitted information by request timer 678.

At block 906, the user of borrower terminal 540 is pre-screen for qualification for a loan. Where qualified, the method 900 is ended. Where not qualified, an alternative assessment is conducted to determine whether a modification to the loan application is possible at block 908. Where a modification is possible, the session is begun at block 902 again. Where a modification is not possible, the method 900 is ended.

FIG. 12 is a flowchart showing a method 1000 for gathering disclosure rules, according to a non-limiting embodiment. The method 1000 is one way in which disclosure rules may be gathered. It is to be emphasized, however, that the blocks of method 1000 need not be performed in the exact sequence as shown. Further, the method 1000 is described as performed by a system and device discussed herein, but this is not limiting and the method can alternatively be performed by other systems and/or devices.

Method 1000 may be performed by a user at a borrower terminal 540 running a session of loan application software 541. Generally, the information may be gathered by prompting the user with questions to obtain information. However, the sequence of questions asked and information gathered may vary to suit the needs of a particular transaction, borrower, or competing financial institution system 530. Further, default options to such questions may be provided for speed and convenience of the user. Answers to questions may selected by drop down menus, tick boxes, or other data entry mechanisms.

At block 1002, the user's anonymity preference is gathered. A user may or may not wish to remain anonymous. Where the user prefers to remain anonymous, the disclosure rules 620 are flagged with the requirement that the user wishes to remain anonymous at block 1004 in disclosure rules 620. Further, the data anonymizer 668 is configured to anonymize any request data 610 in request token 600.

At block 1006, the user's preference to include preference where a financial institution system 530 is to be designated a preferred financial institution system 530-1. A preferred financial institution system 530-1, such as an incumbent financial institution, may be afforded certain disclosure privileges not afforded to other financial institution systems 530. For example, the preferred financial institution system 530-1 may be afforded a right of last offer which allows the preferred financial institution systems 530-1 to make an offer or adjust its previous offer, whether to match a competing offer, improve its previous offer, or otherwise amend its offer in response to the request token 600. This preference option can be configured to have a default selection that gives the preferred financial institution system 530-1 the ROLPO. That is, the borrower may opt out of giving the preferred financial institution system 530-1 the right of last offer. In executing the ROLPO, where the borrower's personal identifying information has been anonymized, the borrower's identity may be deanonymized to the incumbent financial institution system 530-1, whereby the incumbent financial institution system 530-1 may include the borrower's identity into its evaluation of the loan transaction. The user's preference is flagged at block 1008 in disclosure rules 620.

In some embodiments, the disclosure rules 220 can contain another ROLPO option, which can be termed a data-level option, that concerns the degree of personal data to be provided to the preferred financial institution system 530-1, as opposed to the other competing financial institution systems 530. That is, if the preferred financial institution system 530-1 selected to be treated as any other financial institution system 530, then all financial institution systems 530 including the preferred financial institution system 530-1 are provided a request token 600 with the same anonymized/tokenized request data 610. On the other hand, if the preference option is selected to give the preferred financial institution system 530-1 a preferred position in the bidding process, then the data-level option can be configured to offer one or more selections. A first selection for the data-level option provides the preferred financial institution system 530-1 with a bid request that contains personal data of the user. That is, the preferred financial institution system 530-1 is transmitted a modified token that contains more information than the other financial institution systems 530. A second selection for the data-level option provides the preferred financial institution system 530-1 with a modified token that contains only an indication that the user is a client of the preferred financial institution system 530-1. This indication may include an account number or similar. In this case, the preferred financial institution system 530-1 is given a confirmation that the user is a client of the preferred financial institution system 530-1. In any case, the preferred financial institution system 530-1 can use information provided via the data-level option to construct a competitive bid.

At block 1010, where a preferred financial institution system 530-1 is to be designated, the user's preference to inform the preferred financial institution system 530-1 of its designation is gathered. The user's preference is flagged at block 1012 in disclosure rules 620.

At block 1014, the user's preference to generate a lender list is gathered. The user may select a list of financial institution systems 530 to act as lenders, or the list may be provided. The user's preference is flagged at block 1016 in disclosure rules 620.

At block 1018, the user's preference for bidding type is gathered. The bidding type may include a simple request for proposal (RFP), a private auction, or a pre-qualified competition between two or more financial institutions including a preferred financial institution. The user's preference is flagged at block 1020 in disclosure rules 620.

At block 1022, the user's preferences are updated in disclosure rules 620. It is to be understood, however, that logic for carrying out the disclosure rules 620 may be present on request token 600, or may be stored in request manager 672, or in another manner sufficient to give effect to the user's selected preferences in cycles of evaluation of the transaction.

The gathered request data 610 and disclosure rules 620 may be transmitted to server 550, as indicated in FIG. 13, in accordance with block 805 of method 800.

The request token 600, and the request data 610 and disclosure rules 620, may be referred to more generally as a credit decision package (CDP). The CDP may be assembled digitally and retained by the borrower, or retained at server 550 as a service. The CDP may then be used to transmitted to competing financial institution systems 530 as a request for bids for loans, and may be updated periodically.

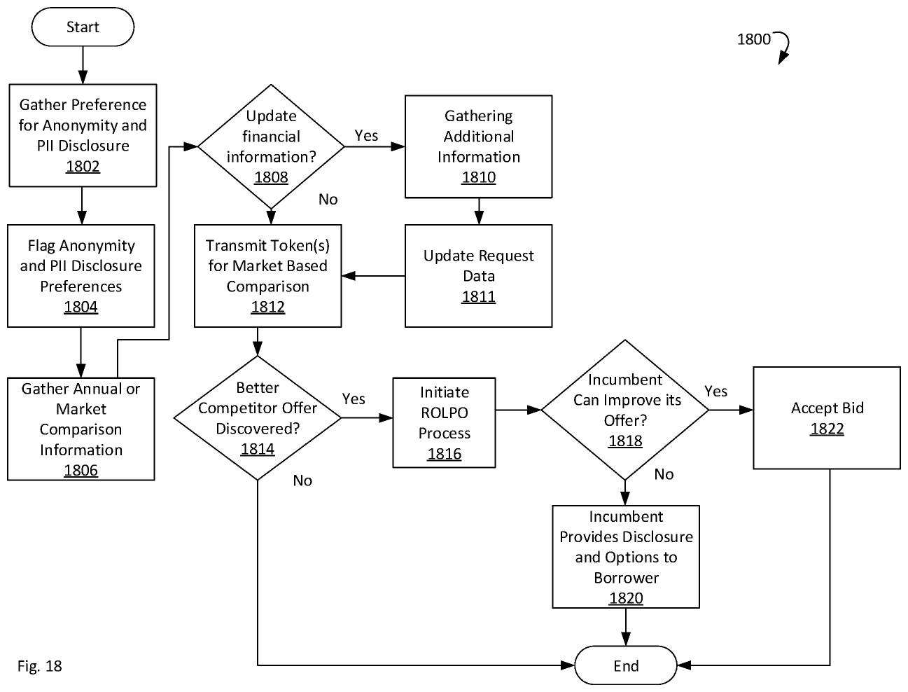

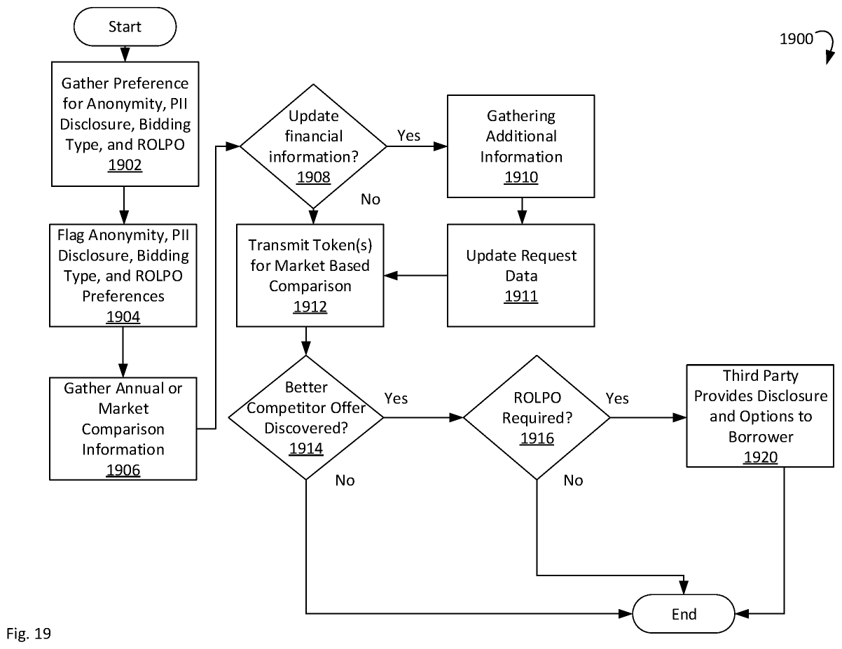

FIGS. 14 through 16 set out methods for executing cycles of evaluation of a request token where bid solicitation is initiated by a borrower. FIGS. 18 through 19, below, set out methods for executing cycles of evaluation of a request token where the bid solicitation is initiated by another party, discussed in greater detail below.

FIG. 14 is a flowchart showing a method 1400 for executing a first cycle of evaluation of a request token, according to a non-limiting embodiment. The method 1400 is one way in which cycles of evaluation of a request token may be executed. It is to be emphasized, however, that the blocks of method 1400 need not be performed in the exact sequence as shown. Further, the method 1400 is described as performed by a system and device discussed herein, but this is not limiting and the method can alternatively be performed by other systems and/or devices.

At block 1402, bids for a loan sought by a user of a borrower terminal 540 are solicited. Bids are solicited by transmission of a request token 600 to the financial institution systems 530. BU data class 630-1 and CR data class 630-2 are disclosed.

At block 1404, it is determined whether an acceptable bid compliant with request data 610 and disclosure rules 620 is offered by a financial institution system 530. Where offered, block 1412 is executed where it is determined whether a right of last preferred offer (ROLPO) is stipulated in the disclosure rules. Where no acceptable bid is offered, it is proposed to provide further disclosure at block 1406.

At block 1406, where no acceptable bid is offered, it is proposed to provide further disclosure. It is determined at block 1408 whether additional disclosure is permitted. In the present example, it is determined whether disclosure of RB data class 630-3 is permitted. Where no further disclosure is permitted, method 1400 is ended.

Where further disclosure is permitted, in some embodiments, the request token 600 is reconfigured to provide the additional disclosure at block 1410, and method 1400 is ended. In other embodiments, where further disclosure is permitted, an additional token which is configured to provide the additional disclosure is transmitted to the financial institution systems 530 at block 1410 (see, e.g. FIG. 5), and method 1400 is ended.

At block 1412, where an acceptable bid was offered by a financial institution system 530, and where it is determined that there is no designated preferred financial institution system 530-1 requiring a ROLPO, the offered bid is accepted at block 1420, and the method 1400 is ended. Where an acceptable bid was offered, and there is a designated preferred financial institution system 530-1 requiring a ROLPO, additional disclosure is provided to the preferred financial institution system 530-1 at block 1414. In some embodiments, CLV data class 630-5 is disclosed. Request token 600 may be reconfigured to CLV disclosure, or an additional token configured for CLV disclosure is transmitted to the preferred financial institution 530-1.

At block 1416, where CLV disclosure has been provided to the preferred financial institution system 530-1, preferred financial institution system 530-1 is afforded an opportunity to make an offer, adjust a previous offer, whether to match a competing offer, improve its previous offer, or otherwise amend its offer, in response to the additional information in the CLV disclosure.

At block 1418, it is determined whether an acceptable bid is to be selected. Where no acceptable bid is to be selected, method 1400 is ended. Where an acceptable bid is to be accepted, the bid is accepted at block 1420, and method 1400 is ended.

FIG. 15 is a flowchart showing a method 1500 for executing a second cycle of evaluation of a request token, according to a non-limiting embodiment. The method 1500 is one way in which cycles of evaluation of a request token may be executed. It is to be emphasized, however, that the blocks of method 1500 need not be performed in the exact sequence as shown. Further, the method 1500 is described as performed by a system and device discussed herein, but this is not limiting and the method can alternatively be performed by other systems and/or devices.

For description of blocks 1502, 1504, 1506, 1508, 1510, 1512, 1514, 1516, 1518, and 1520, reference may be had to analogous blocks of FIG. 14. In the present embodiment of method 1500, at block 1502, RB data class 630-3 is disclosed. Further, at block 1508, it is determined whether CP data class 630-4 is permitted, and at block 1510, a token or tokens are configured for disclosure of CP data class 630-4.

FIG. 16 is a flowchart showing a method 1600 for executing a third cycle of evaluation of a request token, according to a non-limiting embodiment. The method 1600 is one way in which cycles of evaluation of a request token may be executed. It is to be emphasized, however, that the blocks of method 1600 need not be performed in the exact sequence as shown. Further, the method 1600 is described as performed by a system and device discussed herein, but this is not limiting and the method can alternatively be performed by other systems and/or devices.

At block 1602, bids for a loan sought by a user of a borrower terminal 540 are solicited. Bids are solicited by transmission of a request token 600 to the financial institution systems 530. CP data class 630-4 is disclosed.

At block 1604, it is determined whether an acceptable bid compliant with request data 610 and disclosure rules 620 is offered by a financial institution system 530. Where offered, block 1612 is executed where it is determined whether a right of last preferred offer (ROLPO) is stipulated in the disclosure rules. Where no acceptable bid is offered, method 1600 is ended.

At block 1612, where an acceptable bid was offered by a financial institution system 530, and where it is determined that there is no designated preferred financial institution system 530-1 requiring a ROLPO, the offered bid is accepted at block 1620, and the method 1600 is ended. Where an acceptable bid was offered, and there is a designated preferred financial institution system 530-1 requiring a ROLPO, additional disclosure is provided to the preferred financial institution system 530-1 at block 1614. In some embodiments, CLV data class 630-5 is disclosed. Request token 600 may be reconfigured to CLV disclosure, or an additional token configured for CLV disclosure is transmitted to the preferred financial institution 530-1.

At block 1616, where CLV disclosure has been provided to the preferred financial institution system 530-1, competing financial institution systems 530 may be afforded an opportunity to make an offer, adjust a previous offer, whether to match a competing offer, improve its previous offer, or otherwise amend its offer, in response to the additional information in the CLV disclosure.

At block 1618, it is determined whether an acceptable bid is to be selected. Where no acceptable bid is to be selected, method 1600 is ended. Where an acceptable bid is to be accepted, the bid is accepted at block 1620, and method 1600 is ended.

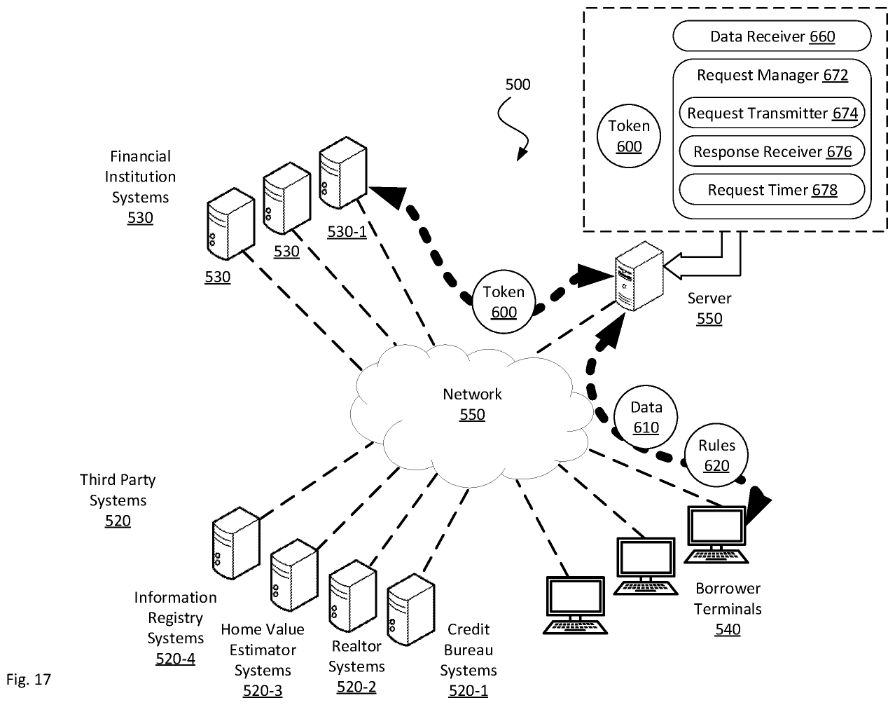

Thus, it can be seen that a series of cycles of evaluation of a request token 600 initiated by a borrower may be executed wherein progressively informative data classes are disclosed to provide additional information relevant to evaluation the loan transaction, as indicated in FIG. 17 below. Cycles of evaluation of the transaction may be executed automatically in succession where all of the required request data 610 and disclosure rules 620 for proceeding through each of the cycles of methods 1400, 1500, and 1600.

Although initiated by a borrower, a preferred financial institution system 530-1 is afforded an opportunity to compete to retain the borrower's business with a ROLPO. A preferred financial institution system 530-1 is thereby provided an opportunity to automate pricing discretion, bundling, and other incentives, to retain business.

Where portions of the request data 610 or disclosure rules 620 are not immediately available at the initiation of method 1400, the necessary data and rules may be acquired. Where a portion of information required for executing cycles of evaluation of the loan transaction is omitted, the omitted information may be gathered between cycles of evaluation of the loan transaction. For example, only information in data classes 630-1 and 630-2 may be gathered initially, whereas information in data class 630-3 may be gathered upon request between second and third cycles of evaluation of the loan request. As discussed above, a timer may be provided for gathering of such omitted information by request timer 678.

In some embodiments, a preferred financial institution system 530-1 may be allocated more time by request timer 678 to respond to a bid request. In some embodiments, the bid request sent to the preferred financial institution system 530-1 is sent after bid requests are sent to other financial institution systems 530. In some embodiments, the bid request sent to the preferred financial institution system 530-1 includes indications of a lowest bid and/or other bids made by other financial institution systems 530. In other embodiments, bid requests sent to the other financial institution systems 530 include an indication of an initial bid made by the preferred financial institution system 530-1, which may be permitted to update its bid after other financial institution systems 530 provide bids. The specific implementation used can be selected to increase competition among the financial institution systems 530, so that the borrower benefits from the competition.

FIGS. 18 through 19 set out methods for executing cycles of evaluation of a request token where the bid solicitation is initiated by a party other than the borrower. FIG. 18 sets out a method for executing a cycle of evaluation of a request token initiated by an incumbent and preferred financial institution system 530-1. FIG. 19 sets out a method for executing a cycle of evaluation of a request token initiated by a trusted third party system 520.

FIG. 18 is a flowchart showing a method 1800 for executing a cycle of evaluation of a request token, according to a non-limiting embodiment. The method 1800 is one way in which cycles of evaluation of a request token may be executed. It is to be emphasized, however, that the blocks of method 1800 need not be performed in the exact sequence as shown. Further, the method 1800 is described as performed by a system and device discussed herein, but this is not limiting and the method can alternatively be performed by other systems and/or devices.

Method 1800 may be executed where the user has consented to annual or on-market demand evaluation cycles, and where the disclosure rules 620 are configured to provide a preferred financial institution system 530-1 with a ROLPO. In some embodiments, a preferred financial institution system 530-1 can thereby conduct a marked-based comparison to assess whether a competing financial institution system 530 may offer the borrower a competing offer, and may assess whether it is advantageous for the preferred financial institution system 530-1 to offer a matching or improved offer. In some embodiments, a preferred financial institution system 530-1 can have a trusted third party system 520 conduct the marked-based comparison. The request data 610 and disclosure rules 620 are thereby through the preferred financial institution system 530-1.

At block 1802, the borrower's anonymity preference is gathered with respect to annual or on-market demand evaluation cycles, which may be initiated by the borrower or by an incumbent financial institution system 530-1. A borrower may or may not wish to remain anonymous. Where the borrower prefers to remain anonymous, the disclosure rules 620 are flagged with the requirement that the borrower wishes to remain anonymous at block 1804. Further, the data anonymizer 668 is configured to anonymize any request data 610 in request token 600.

At block 1806, information for annual or market comparison is gathered. In some embodiments, market information may be gathered from third party systems 520. The products and features of the borrower's requested loan, the selected lenders and lender types, the amount of the loan, and any other changes to the loan request, may be confirmed.

At block 1808, it is determined whether additional financial information is necessary. In some embodiments, financial information may require updating if, for example, the borrower's employment information has changed. Where additional information is to be gathered, additional information may be gathered at block 1810 by loan application software 541 on a borrower terminal 540 via method 900, and the request data 610 in token 600 is updated at block 1811 and transmitted to third party systems 520 to conduct a market based comparison at block 1812. Where additional information is not to be gathered, a request token 600 may be transmitted to third party systems 520 to conduct a market based comparison at block 1812.

At block 1814, it is determined whether a better competitor bid compliant with request data 610 and disclosure rules 620 is discovered as being available for a competing financial institution system 530 to offer to the borrower. Where discovered, block 1816 is executed where the right of last preferred offer (ROLPO) is initiated. Where no acceptable bid is discovered, method 1800 is ended.

At block 1818, it is determined whether the preferred financial institution system 530-1 can improve its offer. Where improvable, the new improved bid is accepted at block 1822, and the method 1800 is ended. Where not improvable, the preferred financial institution system 530-1 can provide the borrower with disclosure options which may facilitate an improved offer at block 1820, and method 1800 is ended.

Thus, by application of method 1800, a preferred financial institution system 530-1 may initiate a cycle and evaluate the market for whether an acceptable bid may be offered to a borrower by a competing financial institution system 530. Where the preferred financial institution system 530-1 can provide an improved offer, a transaction with the borrower may be made. The preferred financial institution system 530-1 can thereby retain the borrower by adjusting its pricing or other incentives.

FIG. 19 is a flowchart showing a method 1900 for executing a cycle of evaluation of a request token, according to a non-limiting embodiment. The method 1900 is one way in which cycles of evaluation of a request token may be executed. It is to be emphasized, however, that the blocks of method 1900 need not be performed in the exact sequence as shown. Further, the method 1900 is described as performed by a system and device discussed herein, but this is not limiting and the method can alternatively be performed by other systems and/or devices.

Method 1900 may be initiated where the user has consented to annual or on-market demand evaluation cycles, and where the disclosure rules 620 are configured to provide a preferred financial institution system 530-1 with a ROLPO. A borrower terminal 540 can have a trusted third party system 520 conduct a marked-based comparison to assess whether a competing financial institution system 530 may offer the borrower a competing offer, and may assess whether it is advantageous for the preferred financial institution system 530-1 to offer a matching or improved offer. The request data 610 and disclosure rules 620 are thereby through a trusted third party system 520.

At block 1902, the borrower's anonymity preference, bidding type preference, and ROLPO preference is gathered with respect to annual or on-market demand evaluation cycles, which may be initiated by a trusted third party system 520. A borrower may or may not wish to remain anonymous. Where the borrower prefers to remain anonymous, the disclosure rules 620 are flagged with the requirement that the borrower wishes to remain anonymous at block 1904, and the data anonymizer 668 is configured to anonymize any request data 610 in request token 600. Further, the trusted third party system 520 may prefer a bidding type including a simple request for proposal (RFP), a private auction, or a pre-qualified competition between two or more financial institutions including a preferred financial institution. The bidding type preference is flagged at block 1020 in disclosure rules 620. Further still, the borrower may or may not wish to provide a ROLPO to a preferred (incumbent) financial institution system 530-1. The borrower's ROLPO preference is flagged in disclosure rules 620.

For description of blocks, 1906, 1908, 1910, 1911, 1912, and 1914, reference may be had to analogous blocks of FIG. 18. In the present embodiment of method 1900, at 1916, where an acceptable bid was offered by a financial institution system 530, and where it is determined that there is a designated preferred financial institution system 530-1 requiring a ROLPO, the trusted third party system 520 can provide the borrower with disclosure options which may facilitate a successful match of an acceptable bid at block 1920, and method 1900 is ended. Where an acceptable bid was offered, and there is no designated preferred financial institution system 530-1 requiring a ROLPO, no bid is accepted, and method 1900 is ended.

Thus, by application of method 1900, a trusted third party system 520 may initiate a cycle and evaluate the market for whether an acceptable bid may be offered to a borrower by a competing financial institution system 530. Where the preferred financial institution system 530-1 can provide a matching offer, a transaction with the borrower may be made, as mediated by a neutral trusted third party system 520.

In other applications, the system described herein may be applied to loan applications, or to the management of other financial transactions, where one party may suffer from informational asymmetry. Further, the system including a ROLPO mechanism allows an incumbent financial institution to retain the business of a borrower shopping for competing products by offering informed pricing options to the borrower.

Generally, a transaction may be evaluated using a request token including the information necessary for a recipient to evaluate the request. Generally, the recipient of the request token would prefer to have as much information as possible prior to making a decision to request or reject the request token. The requester, however, may prefer to withhold information which may damage its bargaining position or anonymity and may prefer to compare offers from a plurality of recipients. Rather than disclosing a large volume of information initially, the request may, using the system discussed herein, progressively disclose additional information relevant for a recipient's evaluation of the request only where an offer to satisfy the request may not be made without disclosure of the additional information.

Successive rounds of requests may be communicated manually between a requester and a recipient. However, a requester's request data, along with disclosure preferences, can be digitally assembled in a request token which may be processed quickly in successive rounds of requests, where information is progressively disclosed, to solicit an offer which satisfies the request and expediently obtain a mutually agreeable acceptance of the request, while retaining privacy of the requester, and shifting informational asymmetry between the requester and the recipient toward the requester.

While the implementations discussed herein are directed to specific implementations of the system, it will be understood that combinations, sub-sets, and variations of the implementations are within the scope of the present disclosure.

The scope of the claims should not be limited by the embodiments set forth in the above examples, but should be given the broadest interpretation consistent with the description as a whole.

1. A system for processing a request token having progressively informative data classes, the system comprising:
a computer network;
a requester;
a plurality of competing recipients;
a server in communication with the requester and the plurality of competing recipients via the computer network, the server configured to execute a method for processing a request token, the method comprising:
receiving request data and disclosure rules from the requester;
classifying the request data into a plurality of progressively informative data classes, the plurality of progressively informative data classes comprising a first data class and a second data class, the second data class including information supplementary to the first data class;
tokenizing the request data according to the plurality of progressively informative data classes to generate a request token configured for disclosure of at least the first data class; and
executing a cycle of evaluation of the request token, the executing comprising:
transmitting the request token to the plurality of competing recipients;
receiving responses to the request token from the plurality of competing recipients; and
where the responses to the request token do not include acceptance of the request token, and where disclosure of the second data class is enabled according to the disclosure rules, configuring the request token for disclosure of at least the second data class, and initiating a subsequent cycle of evaluation of the request token.

2. The system of claim 1, wherein:
the disclosure rules designate a preferred recipient of the plurality of competing recipients;
the method for processing a request token further comprises:
prior to transmitting the request token to the plurality of competing recipients, anonymizing the request data of personal identifying information; and
the executing a cycle for evaluation of the request token further comprises:
where the responses to the request token include acceptance, deanonymizing the request data to include personal identifying information, and providing a right of last preferred offer to the preferred recipient.

3. The system of claim 2, wherein the server is configured to execute the cycle of evaluation of the request token upon request of the preferred recipient, and the receiving request data and disclosure rules from the requester includes routing the request data and disclosure rules through the preferred recipient.

4. The system of claim 2, wherein the system further comprises a third party in communication with the server via the computer network, the server is configured to execute the cycle of evaluation of the request token upon request of the third party, and the receiving request data and disclosure rules from the requester includes routing the request data and disclosure rules through the third party.

5. The system of claim 1, wherein the method for processing a request token further comprises anonymizing the request data of personal identifying information.

6. A system for processing request tokens, the system comprising:
a computer network;
a requester;
a plurality of competing recipients;
a server in communication with the requester and the plurality of competing recipients via the computer network, the server configured to execute a method for processing request tokens, the method comprising:
receiving request data and disclosure rules from the requester;
classifying the request data into a plurality of progressively informative data classes, the plurality of progressively informative data classes comprising a first data class and a second data class, the second data class including information supplementary to the first data class;
tokenizing the request data according to the plurality of progressively informative data classes to generate a first request token configured for disclosure of at least the first data class;
tokenizing the request data according to the plurality of progressively informative data classes to generate a second request token configured for disclosure of at least the second data class; and
executing a cycle of evaluation of request tokens, the executing comprising:
transmitting the first request token to the plurality of competing recipients;
receiving responses to the first request token from the plurality of competing recipients; and
where the responses to the first request token do not include acceptance of the first request token, and where disclosure of the second data class is enabled according to the disclosure rules, transmitting the second request token to the plurality of competing recipients.

7. The system of claim 6, wherein:
the disclosure rules designate a preferred recipient of the plurality of competing recipients;
the method for processing request tokens further comprises:
prior to transmitting the first request token to the plurality of competing recipients, anonymizing the request data of personal identifying information; and
the executing a cycle for evaluation of request tokens further comprises:
where the responses to at least one of the first request token and the second request token include acceptance, deanonymizing the request data to include personal identifying information, and providing a right of last preferred offer to the preferred recipient.

8. The system of claim 7, wherein the server is configured to execute the cycle of evaluation of request tokens upon request of the preferred recipient, and the receiving request data and disclosure rules from the requester includes routing the request data and disclosure rules through the preferred recipient,

9. The system of claim 7, wherein the system further comprises a third party in communication with the server via the computer network, the server is configured to execute the cycle of evaluation of request tokens upon request of the third party, and the receiving request data and disclosure rules from the requester includes routing the request data and disclosure rules through the third party.

10. The system of claim 6, wherein the method for processing request tokens further comprises anonymizing the request data of personal identifying information.

11. A method for processing request tokens, the method comprising:
receiving request data and disclosure rules;
classifying the request data into a plurality of progressively informative data classes, the plurality of progressively informative data classes comprising a first data class and a second data class, the second data class including information supplementary to the first data class;
tokenizing the request data according to the plurality of progressively informative data classes to generate at least one request token configured for disclosure of the first data class;
transmitting the at least one request token configured for disclosure of the first data class to a least one competing recipient;
receiving responses to the at least one request token configured for disclosure of the first data class from the at least one competing recipient; and
where the responses do not include acceptance of the at least one request token configured for disclosure of the first data class, and where disclosure of the second data class is enabled according to the disclosure rules, transmitting at least one request token configured for disclosure of the second data class to the at least one competing recipient.

12. The method of claim 11, wherein the disclosure rules designate a preferred recipient of the at least one competing recipient, the method further comprising:
prior to transmitting the at least one request token configured for disclosure of the first data class to at least one competing recipient, anonymizing the request data of personal identifying information; and
where the responses include acceptance of the request token, deanonymizing the request data to include personal identifying information, and providing a right of last preferred offer to the preferred recipient.

13. The method of claim 11, further comprising anonymizing the request data of personal identifying information.

14. The method of claim 11, further comprising harmonizing the request data to enable each of the at least one competing recipients to evaluate the request token.

15. The method of claim 11, further comprising formatting the request data to be compatible with technical submission requirements of each of the at least one competing recipient.
